(19) United States
(12) Patent Application Publication
(10) Pub. No.: US 2010/0017233 A1
(43) Pub. Date: Jan. 21, 2010

(54) MEDICAL IMAGE MANAGEMENT SYSTEM

(76) Inventor: Haruyuki Toda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/521,246

(22) PCT Filed: Dec. 18, 2007
(86) PCT No.: PCT/JP2007/074307

§ 371 Date: Jun. 25, 2009

(30) Foreign Application Priority Data
Dec. 28, 2006 (JP) 2006-355890

(51) Int. Cl. G06Q 50/00; G06F 17/00; G06F 3/048; G06F 17/30

(52) U.S. Cl. 705/3; 700/90; 715/772; 707/104.1; 707/E17.019

(57) ABSTRACT

The data efficiency of medical image management system is improved. PACS (1) comprises server (2), viewer (3) and console (4) all connected to network (N). The console (4) controls the photographing operation of modality (5) and transmits status information indicating the status of progress status of the photographing operation to the server (2). Accordingly, not only the control of the photographing operation of modality (5) but also the reproduction and display of medical image data and memory management thereof can be carried out on the PACS (1) side, so that failures, such as data generation for compensating for any variance of work flow and generation of useless communication data within the PACS (1), can be avoided.

### TECHNICAL FIELD

The present invention relates to a medical image management system, where a medical image management apparatus for storing and managing medical image data generated by photographing at a medical image photographing apparatus, and a medical image reproducing apparatus for receiving, reproducing, and displaying the medical image data are connected through a network.

### BACKGROUND ART

In the medical field, where medical images taken of patients can be digitized, a medical image photographing apparatus (referred to hereinafter as a “modality”), such as a CR (Computed Radiography), CT (Computed Tomography), MRI (Magnetic Resonance Imaging), mammography, or ultrasonic/endoscopic apparatus, generates image data of medical images obtained by the photographing operation (hereinafter, “medical image data”).

Developments in the digitization of medical image have facilitated integration between different systems. For example, the PACS (Picture Archiving and Communication System) is known that comprises a server (a medical image management apparatus) for storing and managing the medical image data generated by a modality and a client terminal (a medical image reproducing apparatus) for reproducing and displaying the stored and managed medical image data.

A photographing control apparatus (referred to hereinafter as a “console”) is also known as an apparatus for controlling photographing operation of a modality (see, for example, Patent Document 1). The console controls when to start photographing by the modality, and successively transfers the medical image data obtained by the photographing operation to the PACS, according to an order from a system such as HIS (Hospital Information System) or RIS (Radiological Information System).

### (Patent Document 1: Japanese Patent Laid-Open No. 2002-219122)

### DISCLOSURE OF THE INVENTION

### Problems to be Solved by the Invention

Meanwhile, consoles are generally provided by vendors that manufacture the modalities as an object for photographing control. However, if the PACS vendor is different from the console vendor, there may exist differences or inconsistent workflow (examination flow) between the PACS and the console in the way of handling medical image data transmitted and received therebetween. As such, there are deficiencies due to unnecessary communication data or data for compensating the difference in workflow between the PACS and the console, which would reduce the data efficiency of medical image management systems.

In addition, medical image data is transmitted from a console to the PACS, after it is once reproduced and displayed at the console and image processing is performed on the medical image as appropriate, and when a confirmation instruction is input by a user. However, if a console could not transmit medical image data due to a delay in its image processing, the absence of confirmation instruction input by the user, etc., the medical image data will be temporarily stored in a storage section of the console. In this case, it is necessary to provide a storage section with large capacity at the console for storing such medical image data, which would increase hardware costs of medical image management systems.

In addition, while medical image data generated by different modalities can be referenced semi-permanently, in medical practice, it is often referenced at predetermined times of day, such as immediately after photographing or surgery hours. However, as described in Patent Document 1, when medical image data generated by modalities is successively transferred to a server in PACS, intensive access will be made by clients to the server at predetermined times of day, which would result in degradation of the server's performance.

Furthermore, some of the medical image data that has been confirmed and checked by a user such as an imaging engineer at a modality console may not actually be referenced by a doctor who interprets radiograms. If such medical image data flows on the network at predetermined times of day during which the medical images would be referenced more frequently, then a decrease in communication speed between a server and client terminals will result, which would increase the load on the network and result in waste of the network resources.

The present invention has been made in view of the above-mentioned problems, and an object of the invention is to improve data efficiency of the medical image management system.

### Means for Solving the Problems

To solve the problems, the invention of claim 1 provides:

a medical image management system, in which a medical image management apparatus and a medical image reproducing apparatus are connected through a network, comprising:

the medical image management apparatus for storing and managing medical image data generated by photographing operation of a medical image photographing apparatus; and

the medical image reproducing apparatus for receiving the medical image data, and reproducing and displaying the medical image data,

the medical image reproducing apparatus comprising:
a photographing control section for controlling the photographing operation of the medical image photographing apparatus;
a generating section for generating status information indicative of a progress status of the photographing operation of the medical image photographing apparatus based on the controlling by the photograph control section; and
a status transmission section for transmitting the status information generated by the generating section to the medical image management apparatus, and

the medical image management apparatus comprising:
a list preparing section for preparing the list data indicative of the progress status of the photographing operation for each of the medical image data to be generated by the medical image photographing apparatus; and
an update section for updating the list data prepared by the list preparing section, based on status information transmitted from the medical image reproduction apparatus.

According to claim 2, the invention of claim 1 is characterized in that:

the medical image management apparatus further comprises:
a receiving section for receiving the medical image data generated by the medical image photographing apparatus;
a storage section for accumulating and storing the medical image data received by the receiving section; and
a transmission control section for reading, from the storage section, the medical image data corresponding to an acquisition request from the medical image reproduction apparatus, and transmitting the read medical image data to the medical image reproduction apparatus through the network, and

the medical image reproduction apparatus further comprises:
a request transmission section for transmitting, to the medical image managing apparatus, the acquisition request of the medical image data for which the photographing operation is started by controlling the medical image photographing apparatus by the photographing control section; and

a reproduction control section for receiving the medical image data transmitted from the medical image management apparatus in response to the acquisition request from the request transmission section, and reproducing and the displaying the received medical image data.

According to claim 3, the invention of claim 1 is characterized in that:

the medical image reproducing apparatus further comprises:
a receiving section for receiving the medical image data generated by the medical image photographing apparatus;
a temporary storage section for temporarily accumulating and storing the medical image data received by the receiving section; and
a transmission control section for reading, from the temporary storage section, the medical image data corresponding to an acquisition request from another apparatus, and transmitting the read medical image data to the another apparatus through the network.

According to claim 4, the invention of claim 3 is characterized in that:

the medical image reproducing apparatus further comprises:
a selection section for selecting the medical image data stored in the temporary storage section according to operation by a user; and
a reproduction display control section for reading the medical image data selected by the selection section from the temporary storage section, and reproducing and displaying the medical image data.

According to claim 5, the invention of claim 3 or 4 is characterized in that:

the medical image reproducing apparatus further comprises a temporarily stored image transmission section for transmitting the medical image data stored in the temporary storage section to the medical image management apparatus at a predetermined time, and

the medical image management apparatus further comprises a storage section for receiving the medical image data transmitted from the medical image reproducing apparatus at the predetermined time, and accumulating and storing the received medical image data.

### EFFECTS OF THE INVENTION

According to the invention of claim 1, the medical image reproducing apparatus controls the photographing operation of the medical image photographing apparatus, and transmits status information indicative of the progress status of the photographing operation. According to this, since it is possible to perform the control of the photographing operation of the medical image photographing apparatus in a side of the medical image management system, it is possible to solve the deficiencies due to unnecessary communication data or data for compensating the difference in workflow in the side of the medical image management system side. Accordingly, it is possible to prevent to reduce the data efficiency of medical image management systems.

According to the invention of claim 2, it may, of course, provide the same advantages as the invention of claim 1, wherein the medical image management apparatus receives, accumulates and stores the medical image data from the medical image photographing apparatus, and transmits the medical image data corresponding to the acquisition request from the medical image reproducing apparatus to the medical image reproducing apparatus. That is, since the medical image management apparatus integrally stores and manages the medical image data from the medical image photographing apparatus, it is not necessary to provide a storage section having a large capacity in the medical image reproducing apparatus, which controls the photographing operation of the medical image photographing apparatus. Accordingly, it is possible to prevent to increase hardware costs of medical image management systems.

According to the invention of claim 3, it may, of course, provide the same advantages as the invention of claim 1, wherein the medical image reproducing apparatus receives and temporarily stores the medical image data from the medical image photographing apparatus, and transmits the medical image data in response to the acquisition request from another apparatus. According to this, since it is not necessary to transmit medical image data every time to photograph the medical image data, it is possible to prevent to result in degradation of the server's performance.

According to the invention of claim 4, it may, of course, provide the same advantages as the invention of claim 3, wherein the medical image reproduction apparatus reads the medical image data selected according to operation by a user from the temporary storage section, and reproduces and displays the medical image data, it is not necessary to communicate with the medical image management apparatus to acquire the medical image data. Accordingly, it is possible to prevent to increase the load on the network with respect to the medical image management system.

According to the invention of claim 5, it may, of course, provide the same advantages as the invention of claim 3 or 4, wherein since the medical image reproducing apparatus transmits the medical image data stored in the temporary storage section at a predetermined time to the medical image management apparatus, it is possible to transmit the medical image data to the medical image management apparatus at predetermined time other than time during which the medical images would be referenced more frequently, and prevent to increase the load on the network.

### EXPLANATION OF REFERENCE NUMERAL

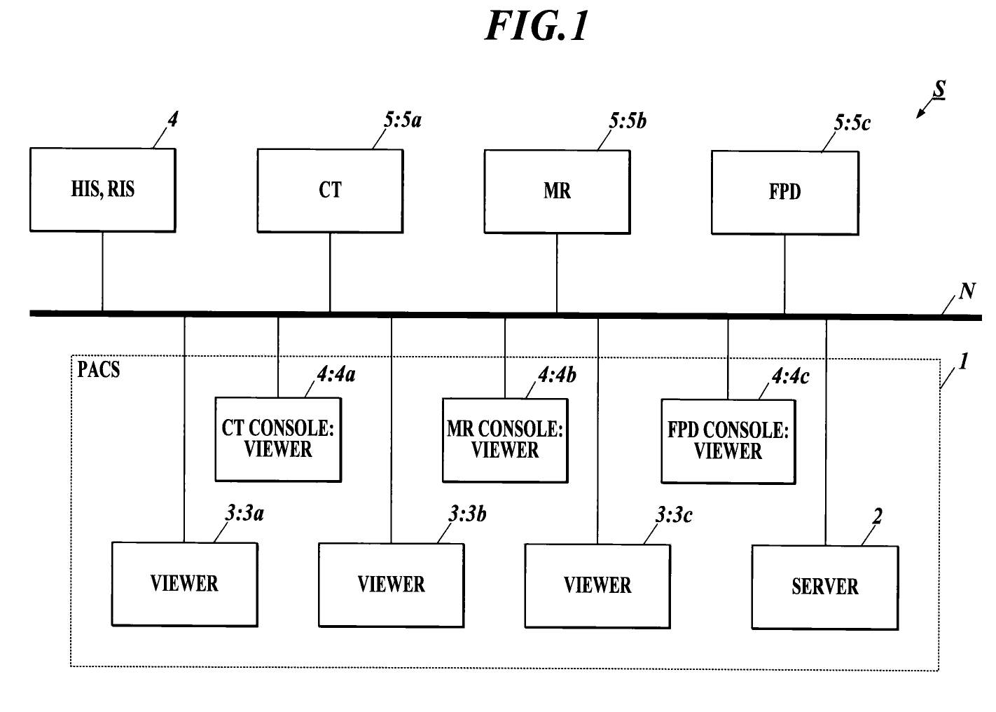

FIG. 1 is a block diagram illustrating an example system configuration of a medical image management system;

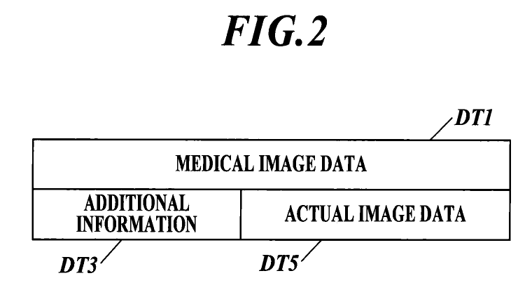

FIG. 2 illustrates an example data structure of medical image data;

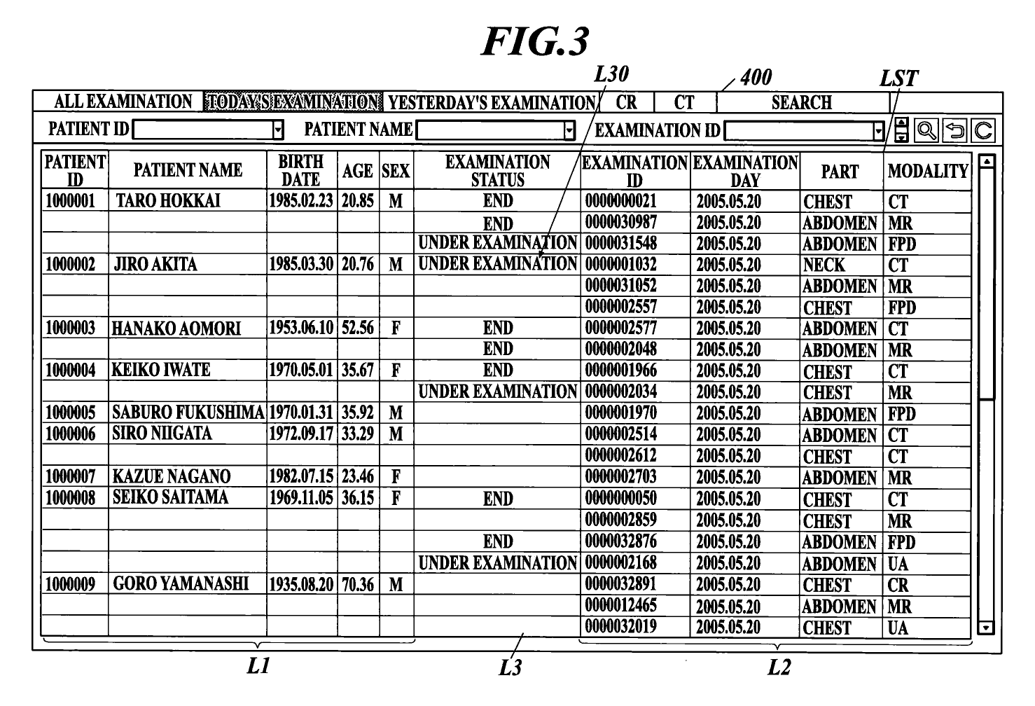

FIG. 3 illustrates an example screenshot of an image selection screen;

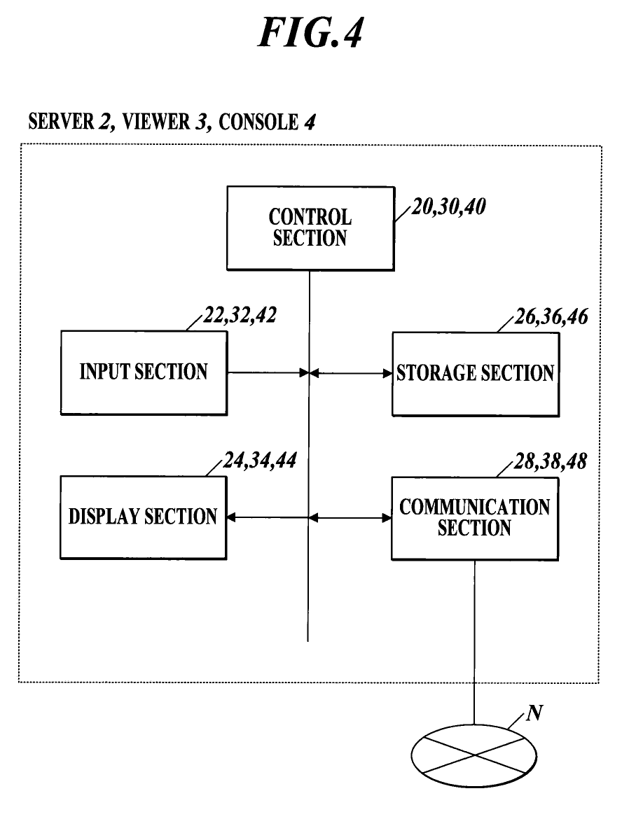

FIG. 4 illustrates an example functional configuration of a server, a viewer and a console;

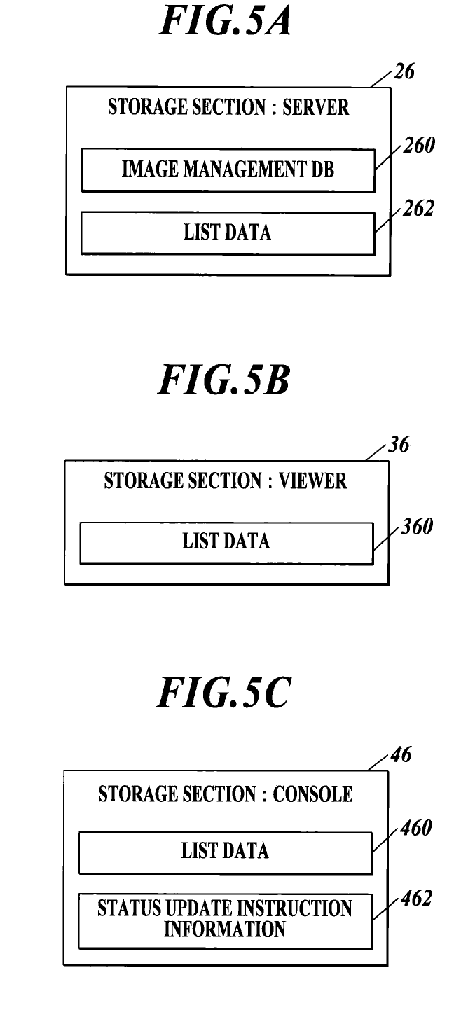

FIG. 5A illustrates an example data configuration of a storage section in a server in the first embodiment;

FIG. 5B illustrates an example data configuration of a storage section in a viewer in the first embodiment;

FIG. 5C illustrates an example data configuration of a storage section in a console in the first embodiment;

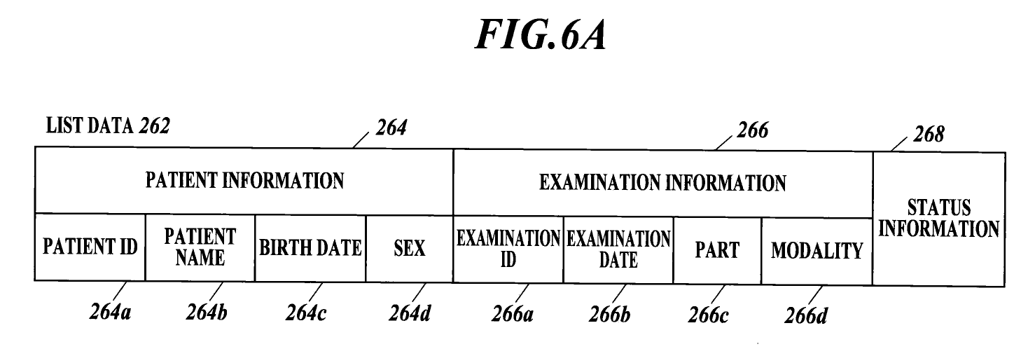

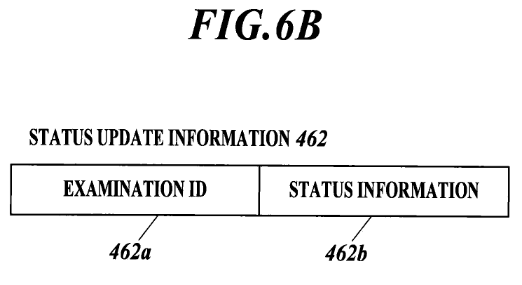

FIG. 6A illustrates an example data configuration of list data in the first embodiment;

FIG. 6B illustrates an example data configuration of status update information in the first embodiment;

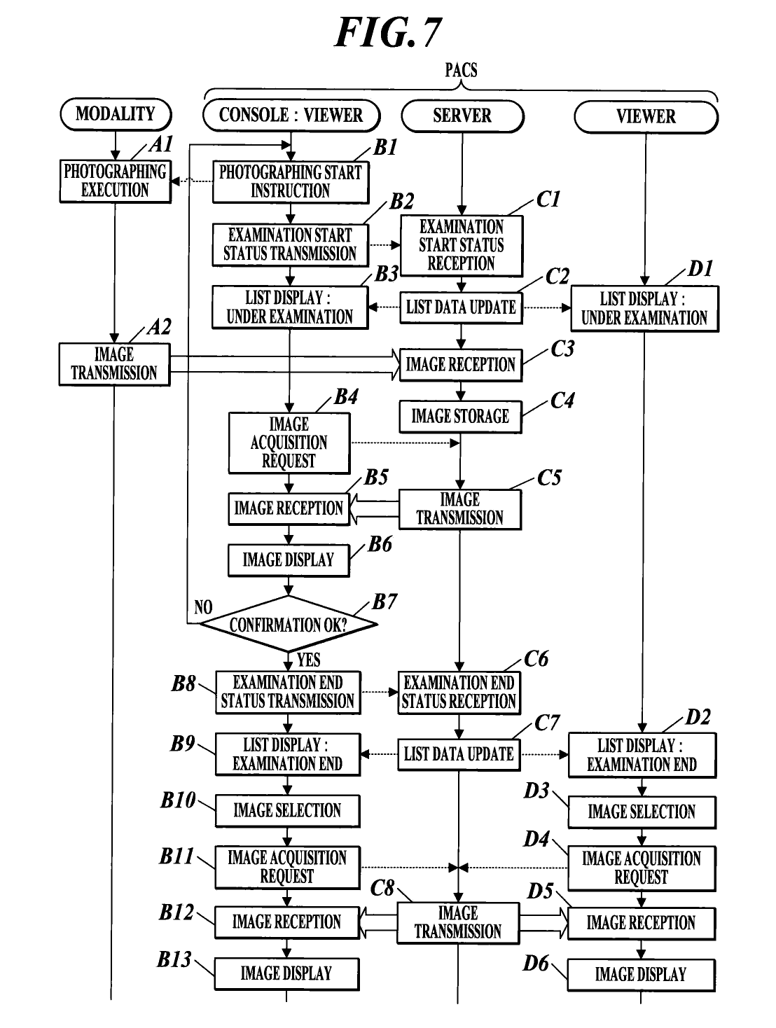

FIG. 7 is a flowchart illustrating a specific operation of a medical image management system in the first embodiment;

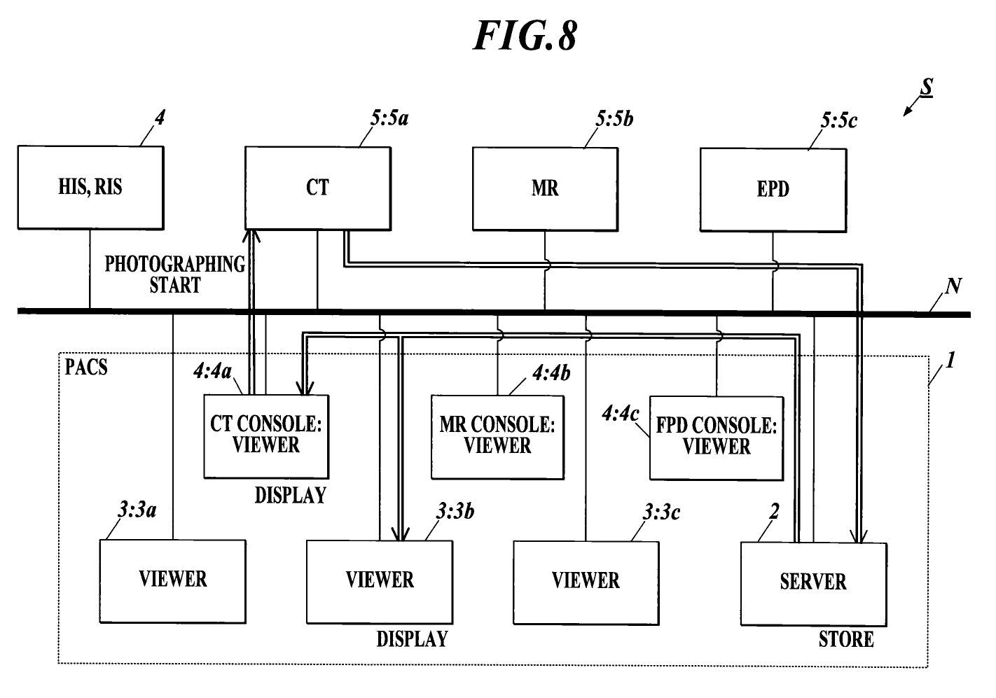

FIG. 8 illustrates an example operation of a medical image management system in the first embodiment;

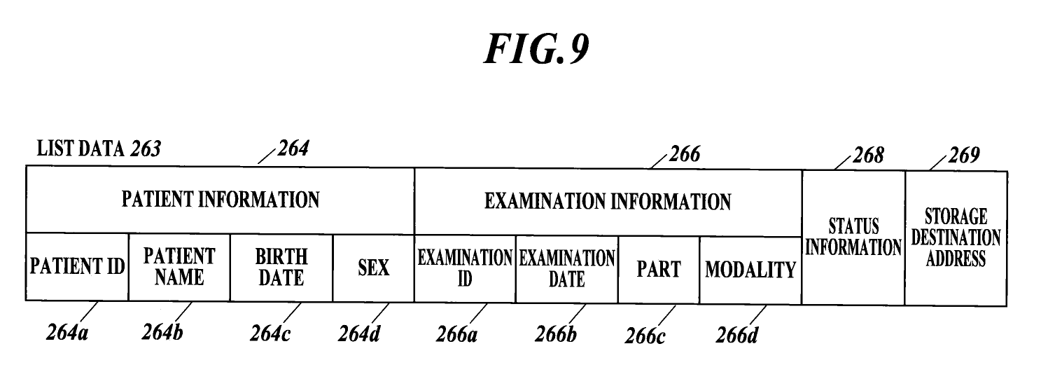

FIG. 9 illustrates an example data configuration of list data in the second embodiment;

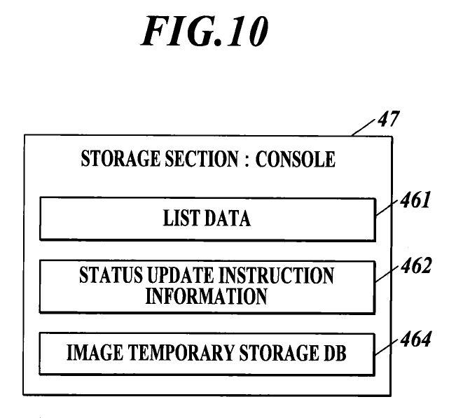

FIG. 10 illustrates an example data configuration of a storage section in a console in the second embodiment;

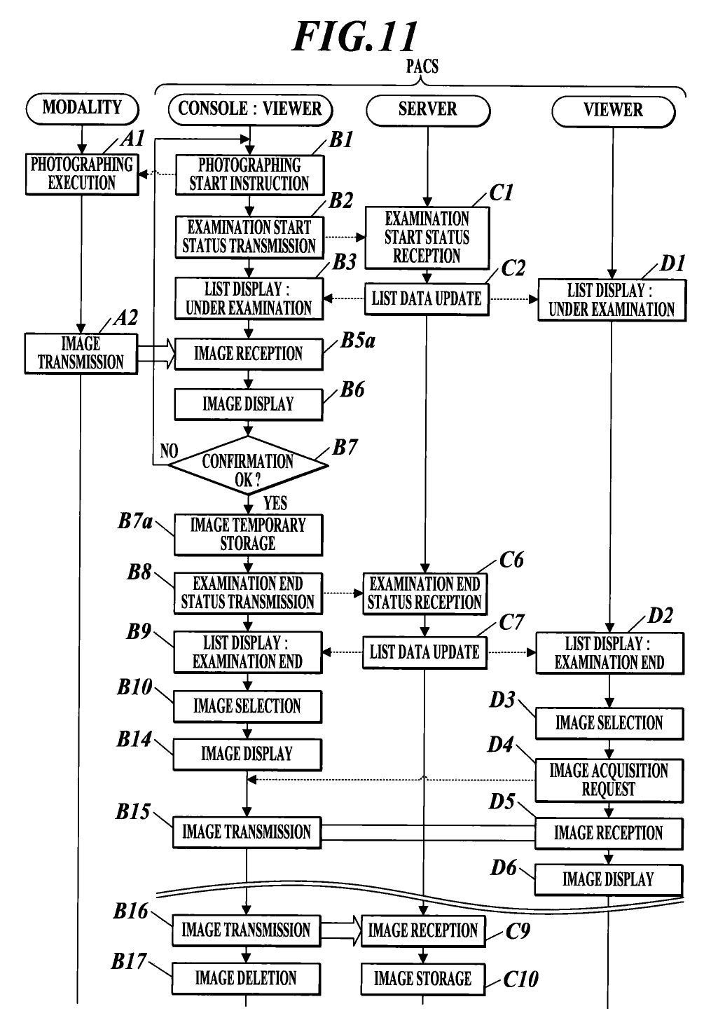

FIG. 11 is a flowchart illustrating a specific operation of a medical image management system in the second embodiment; and

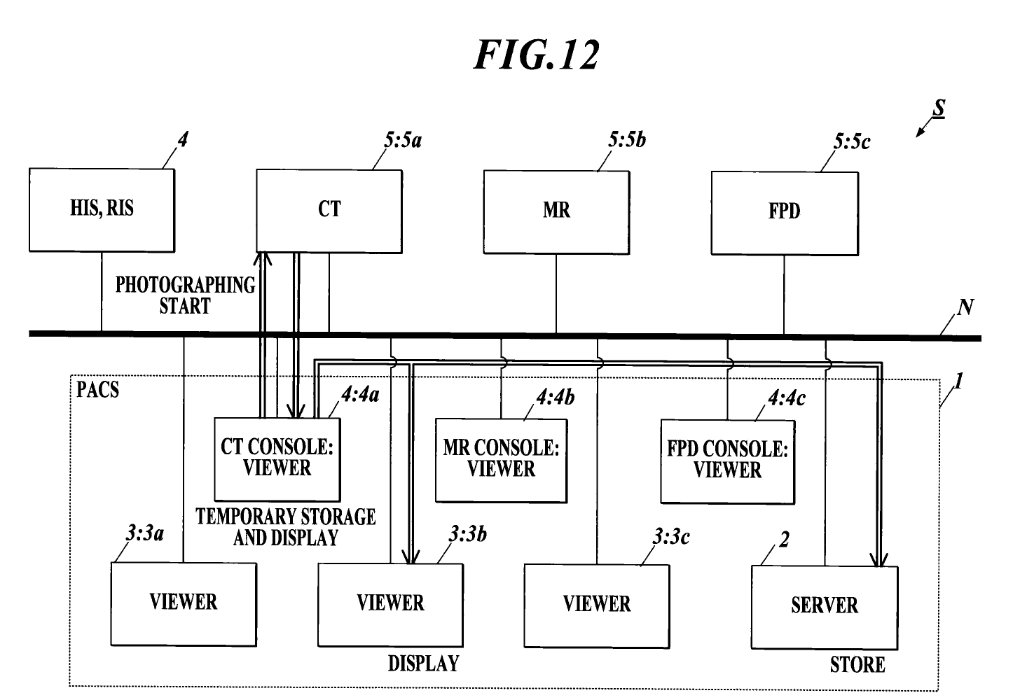

FIG. 12 illustrates an example operation of a medical image management system in the second embodiment.

### BEST MODE FOR CARRYING OUT THE INVENTION

### First Embodiment

A first embodiment of the PACS applying a medical image management system according to the present invention will be described below with reference to FIGS. 1 to 8.

### <PACS Overview>

Referring first to FIG. 1, an overview of the PACS 1 is given below. FIG. 1 is a block diagram illustrating an example system configuration of the PACS 1. As illustrated in FIG. 1, the PACS 1 comprises a server 2, a plurality of viewers (clients) 3, and consoles 4 with functions of the viewers 3, all of which are connected to an intra-hospital network N. The PACS 1 is connected to be able to communicated data with HIS, RIS 4 and different modalities 5 via the intra-hospital network N.

The HIS (Hospital Information System) comprises a computer that has a CPU (Central Processing Unit), a storage section including ROM (Read Only Memory) and RAM (Random Access Memory), an input section, a display section, a communication section, etc. The HIS manages comprehensive hospital information, such as medical billing, appointment, electronic medical chart management, examination, or medicine orders to appropriate departments.

The RIS (Radiological Information System) comprises a computer that has a CPU, a storage section, an input section, a display section, a communication section, etc. The RIS manages comprehensive information of the radiology system: it manages information in the radiology department, such as appointments, diagnosis reports, medical records, or material inventory management.

The HIS, RIS 4 accepts a photographing order from a doctor and generates order information including the content of the order. Then, the order information is transmitted to a console 4 and a server 2 via the intra-hospital network N. The order information is such data that contains patient information of a patient to be photographed, such as name, ID, or sex, and examination information indicative of examination conditions, such as an examination ID that identifies the examination ordered by a doctor, examination parts, photographing directions, or patient positions.

The modalities 5 convert the data signals of the images that are photographed according to the operation by imaging engineers into digital data compliant with the DICOM standard to generate medical image data, which is in turn transmitted to the PACS 1. The modalities 5 include a CT 5a, an MRI 5b, and an FPD 5c as illustrated in FIG. 1, as well as a CR, mammography apparatus, ultrasonic diagnosis apparatus, etc.

FIG. 2 illustrates an example data structure of medical image data DT1. As illustrated in FIG. 2, the medical image data DT1 comprises additional information DT3 and actual image data DT5. The actual image data DT5, which is image data for the image of an object photographed by a modality 5, is provided in a data format compliant with the DICOM standard.

The additional information DT3 comprises an AE (Application Entity) title identifying a modality 5 that generates medical image data DT1, patient information such as patient IDs, patient names, or birth dates, and examination information such as examination IDs, examination dates and times, or examination parts. For example, the additional information DT3 includes such data that is described under the DICOM standard based on the order information received from the HIS, RIS 4.

Each of the modalities 5 has a console 4. The consoles 4 are medical image reproducing apparatuses with functions for controlling photographing operations of different modalities 5, such as when to start or end the photographing operations, and for reproducing and displaying medical image data. The consoles 4 are configured to be able to communicate data with the modalities 5 either directly or through the intra-hospital network N.

As illustrated in FIG. 1, the consoles 4 include a CT console 4a for controlling photographing operation of the CT 5a, an MRI console 4b for controlling photographing operation of the MRI 5b, an FPD console 4c for controlling photographing operation of the FPD 5c, and so on.

For example, a modality 5 and a console 4 corresponding to that modality 5 are provided as a combined pair: the CT console 4a is provided adjacent to the CT 5a, and so on. A user, such as an imaging engineer, operates a console 4 to provide instructions to start and end the photographing operation of the modality 5.

The medical image data DT1 generated by a modality 5 is transmitted to the server 2. This can be done by setting a destination address to which the modality 5 transmits medical image data.

Upon receipt of the medical image data DT1 from the modality 5, the server 2 stores the medical image data DT1 in a storage section 26 (see FIG. 4), which data will be read and transmitted by the server 2 in response to an acquisition request from a console 4 or a viewer 3.

The console 4 receives, reproduces and displays the medical image data DT1 generated by the modality 5 from the server 2, and it performs image processing on it according to user instructions. In addition, the console 4 manages the progress status (referred to hereinafter as “status”) of photographing (examination) by the modality 5 to notify the server 2 in the PACS 1 of the status.

The server 2 is a medical image management apparatus that makes a database of the medical image data DT1 generated by the modalities 5 and that stores and manages the medical image data DT1 in the database. When an instruction is input at a viewer 3 or a console 4 to reproduce and display medical image data DT1 that is stored and managed by the server 2, the server 2 reads the medical image data DT1 in question from the storage section 26, which is then transmitted to the viewer 3 or the console 4.

In addition, the server 2 prepares a list of the different information about the medical images photographed at the different modalities 5, based on the order information transmitted from the HIS, RIS 4 and a notification of the status change from the console 4. The prepared list is delivered to the consoles 4 and the viewers 3.

FIG. 3 illustrates an example screenshot of an image selection screen 400 in which a list LST is displayed. As illustrated in FIG. 3, the list LST comprises: patient information section L1 for displaying patient information, such as patient IDs, patient names, birth dates, ages or sexes; examination information section L2 for displaying examination information, such as examination IDs, examination days, examination parts, or modalities; and examination status section L3.

The examination status section L3, which is a section for displaying the status of the examination indicated by examination ID, displays the status of “END” when the examination has already been completed, “UNDER EXAMINATION” when the examination is in progress, and so on. For example, it can be seen from FIG. 3 that the examination corresponding to examination ID “0000000021” is performed at the CT 5a and that it has already been completed because its examination status denotes “END”.

The viewers 3 are medical image reproducing apparatuses that reproduce and display medical images based on medical image data DT1. Each of the viewers 3 obtains and displays list data (described below) from a server 2 for displaying the list LST, as illustrated in FIG. 3. Upon selection of a desired examination ID by a user, the medical image data DT1 corresponding to the examination ID is transmitted from the server 2, and the medical image data DT1 is reproduced and displayed.

That is, such a client-server system is achieved by the server 2, the viewers 3, and the consoles 4, wherein distributed functions are provided for storing and managing medical image data DT1, for reproducing and displaying medical image data DT1, and for controlling photographing operation of a modality 5, respectively.

### <Console, Server, and Viewer Functional Configuration>

Referring now to FIGS. 4 to 6B, a functional configuration of a server 2, a viewer 3, and a console 4 will be described below. Note that the server 2, the viewer 3, and the console 4 may be implemented with general-purpose computers and their main components are the same. Thus, the block diagram of FIG. 4 illustrates a representative functional configuration.

### <Server>

The server 2 comprises a control section 20, an input section 22, a display section 24, a storage section 26, and a communication section 28. The control section 20, which includes a CPU, ROM, RAM, etc, comprehensively manages and controls the server 2 by controlling operation of respective functional parts, data input and output between the functional parts, and so on.

Specifically, the control section 20 reads program stored in the ROM or the storage section 26 in response to a operation signal input from the input section 22, and performs operations according to the program. Then, based on the operation results, it performs other operations, such as updating the display screen of the display section 24, storing data in the storage section 26, or communicating data with external devices.

The input section 22 comprises different groups of keys, such as cursor keys or numeric keys, and a pointing device, such as a mouse or touch panel. The input section 22 outputs to the control section 20 operation signals that correspond to the keys pressed by a user and to the coordinate positions on the screen specified by a pointing device.

The display section 24, which comprises a CRT (Cathode-ray Tube), an LCD, etc., displays a screen based on the control of the control section 20. The communication section 28, which comprises a LAN interface, etc., is a functional part for communicating data between a viewer 3 and a console 4 via the intra-hospital network N.

The storage section 26, which comprises an HDD (Hard Disk Drive), etc., is a functional part for reading data from and writing data to a magnetic or optical storage medium. FIG. 5A illustrates an example data configuration of the storage section 26. As illustrated in FIG. 5A, the storage section 26 stores an image management DB 260 and list data 262.

The image management DB 260 is a database that accumulates and stores the medical image data DT1 received from a modality 5. Upon receipt of medical image data DT1 generated by a modality 5, the control section 20 stores it in the image management DB 260 so that it can be retrieved later based on the additional information DT3 contained in the medical image data DT1.

The list data 262, which is display data for displaying the list LST illustrated in FIG. 3, is configured with the data configuration as illustrated in FIG. 6A. That is, the list data 262 is configured with patient information 264 including patient ID 264a, patient name 264b, birth date 264c, and sex 264d, examination information 266 including examination ID 266a, examination date 266b, part 266c, and modality type 266d, and status information 268.

The patient information 264 and the examination information 266 of the list data 262 are set based on order information transmitted from the HIS, RIS 4. Upon receipt of the order information from the HIS, RIS 4, the control section 20 extracts the patient information 264 and the examination information 266 from the order information to accumulate and store them in the list data 262.

The status information 268 is such data that indicates the progress status of the examination indicated by the patient information 264 and the examination information 266 corresponding to the status information 268. When the patient information 264 and the examination information 266 are stored in the list data 262, invalid data is stored in the status information 268 as initial data.

Then, when data is transmitted from a console 4 to the server 2 indicating that the examination has been started (status update instruction information 462, described below), the status information 268 in the list data 262 is updated to data indicating that the examination is in progress. In addition, when data is transmitted from the console 4 to the server 2 indicating that the examination has been completed, the status information 268 is updated to data indicating the completion of the examination.

### <Viewers>

As illustrated in FIG. 3, each viewer 3 in the PACS comprises a control section 30, an input section 32, a display section 34, a storage section 36, and a communication section 38. Note that the respective functional parts of the viewers 3 have the same configuration as those of the server 2, and so will not be described in detail below.

FIG. 5B illustrates an example data configuration of the storage section 36 in each viewer 3. As illustrated in FIG. 5B, the storage section 36 stores list data 360. The list data 360 has the same data configuration as that of the list data 262 stored at server 2 side.

Each time list data 262 is updated at server 2 side, the updated list data 262 is transmitted to the viewers 3 via the network N, where it is overwritten and updated as list data 360. Based on the list data 360, the viewers 3 can also display the same list LST as the server 2, illustrated in FIG. 3.

A user references this list LST to select a list to be reproduced and displayed. If the status information corresponding to the list selected based on the operation signals from the input section 32 is invalid data, or if it indicates that the examination is in progress, the control section 30 causes the display section 34 to display a message that the medical image data DT1 corresponding to the list cannot be reproduced or displayed.

In addition, if the status information indicates that the examination has been completed, then the control section 30 requests acquisition of the medical image data DT1 by extracting an examination ID of the medical image data DT1 from the list data 360 and transmitting it to the server 2.

At this point, at server 2 side, the medical image data DT1 containing the patient ID 264a and the examination ID 266a is read from the image management DB 260 and transmitted to a viewer 3. The viewer 3 receives the medical image data DT1 transmitted from the server 2, which is in turn reproduced and displayed on the display section 34.

### <Consoles>

As illustrated in FIG. 3, each console 4 comprises a control section 40, an input section 42, a display section 44, a storage section 46, and a communication section 48. The respective functional parts of the consoles 4 have substantially the same configuration as those of the server 2.

While the communication section 48 in each console 4 comprises a LAN interface or the like as in the server 2 and the viewers 3, for example, it may comprise a serial interface to receive medical image data DT1, which is used to directly transmit instruction data (e.g., commands) to a modality 5 for controlling photographing operation thereof.

FIG. 5C illustrates an example data configuration of the storage section 46 in each console 4. As illustrated in FIG. 5C, the storage section 46 stores list data 460 and status update instruction information 462. The list data 460 has the same data configuration as that of the list data 262 stored at server 2 side.

Each time list data 262 is updated at server 2 side, the updated list data 262 is transmitted from the server 2 to the consoles 4 via the network N, where it is updated as list data 460. Based on the list data 460, the consoles 4 can also display the same list LST as the server 2, illustrated in FIG. 3.

In addition, a user references this list LST to select a list to be reproduced and displayed. If the status information corresponding to the list selected based on the operation signals from the input section 42 is invalid data, or if it indicates that the examination is in progress, the control section 40 causes the display section 44 to display a message that the medical image data DT1 corresponding to the list cannot be reproduced.

In addition, if the status information indicates that the examination has been completed, then the control section 40 requests acquisition of the medical image data DT1 by extracting an examination ID of the medical image data DT1 from the list data 460 and transmitting it to the server 2.

At this point, at server 2 side, the medical image data DT1 containing the patient ID 264a and the examination ID 266a is read from the image management DB 260 and transmitted to a console 4. At the console 4, the medical image data DT1 transmitted from the server 2 is reproduced and displayed on the display section 44.

The status update instruction information 462 comprises examination ID 462a and status information 462b, as in the example data configuration of FIG. 6B. The status update instruction information 462 is such data for instructing update of the status information 268 in the list data 262 stored at the server 2. The status information 462b is such data that indicates the progress status of photographing and examination by a modality 5.

Upon receipt of order information from the HIS, RIS 4, the control section 40 schedules the photographing and examination of the modality 5 based on that order information. Then, according to the scheduling, the control section 40 outputs a photographing start instruction to the modality 5 via the communication section 48, causing the modality 5 to perform the photographing and examination.

The control section 40 controls the photographing and examination of the modality 5 and generates status information 462b corresponding to the progress status. Then, the control section 40 reads examination ID 462a of the examination performed at the modality 5 from the list data 460, and associates it with status information 462b to provide status update instruction information 462, which is in turn transmitted to the server 2 in the PACS 1.

At this point, based on the status update instruction information 462 transmitted from the corresponding console 4, the status information 268 in the list data 262 is updated at the server 2. Specifically, when the modality 5 starts photographing, the console 4 transmits the status update instruction information 462 including the status information 462b indicative of the start of the examination to the server 2. In addition, when the photographing is completed, the console 4 transmits the status update instruction information 462 including the status information 462b indicative of the completion of the examination is transmitted.

On the other hand, upon receipt of the status update instruction information 462, the server 2 searches the list data 262 for examination information 266 that has the examination ID 462a included in the status update instruction information 462. Then, the server 2 overwrites and updates the status information 268 associated with the examination information 266 with the status information 462b.

That is, when the console 4 starts photographing a medical image, the status information 268 in the list data 262 is rewritten to data indicating that the examination is in progress through transmission and reception of the status update instruction information 462; whereas when the photographing is completed, the status information 268 is rewritten to data indicating that the examination is completed.

In addition, the console 4 transmits an acquisition request to the server 2 for acquiring the medical image data DT1 for which photographing is started by controlling the modality 5. Then, the console 4 receives the photographed medical image data DT1 from the server 2. In addition, the console 4 reproduces and displays the received medical image data DT1, and performs image processing on it in response to the user operation. Furthermore, when a confirmation instruction from the input section 42 is detected, the console 4 generates status update instruction information 462 including the status information 462b indicative of the completion of the examination, which is then transmitted to the server 2. In this way, the list data 262 stored at server 2 side is updated.

### <Specific Operation of Medical Image Management System>

Referring now to FIGS. 7 and 8, a specific operation of the PACS 1 will be described below. FIG. 7 is a flowchart illustrating a specific operation of the PACS 1; and FIG. 8 illustrates an example operation of the PACS 1. Note that while the operations illustrated in the flowchart of FIG. 7 are performed by the control sections of a modality 5, a console 4, a server 2, and a viewer 3, respectively, for ease of description, the following description is given from the viewpoint of these apparatuses.

Firstly, the console 4 transmits a photographing start instruction to a modality 5 in question based on order information received from the HIS, RIS 4 (step B1), and transmits status update instruction information 462 indicative of the start of the examination to the server 2 (step B2).

The server 2 generates list data 262 based on order information received from the HIS, RIS 4 and transmits the list data 262 to a viewer 3, causing the viewer 3 to display the image selection screen 400 as illustrated in FIG. 3.

Then, if status update instruction information 462 is received from the console 4 (step C1), then the server 2 updates the list data 262 based on the status update instruction information 462 (step C2). The server 2 then transmits the updated list data 262 to the viewer 3 (step C2), causing the viewer 3 to update the image selection screen 400 (step D1).

In FIG. 8, the CT console 4a instructs the CT 5a to start photographing, and the status update instruction information 462 is transmitted from the CT console 4a to the server 2. At this point, given that the status update instruction information 462 received at the server 2 has examination ID 462a of ‘0000001032’ and status information 462b of “UNDER EXAMINATION”, then the status information of the list data is rewritten based on the status information 462b, and the examination status L30 with examination ID of ‘0000001032’ is updated to indicate “UNDER EXAMINATION”, as illustrated in FIG. 3.

Then, upon completion of the photographing of the medical image at the modality 5, the medical image data DT1 is transmitted to the server 2 as with the CT 5a and the server 2 in FIG. 8 (step A2). Upon receipt of the medical image data DT1 (step C3), the server 2 stores the medical image data DT1 in the image management DB 260 (step C4).

On the other hand, in order to acquire medical image data DT1 under examination in list data 460 from the server 2, the console 4 transmits an acquisition request to the server 2 for the medical image data DT1, by transmitting an examination ID under examination contained in the list data 460 (step B4).

In response to the acquisition request, if the server 2 has already received medical image data DT1 containing the received examination ID from the modality 5, and if the medical image data DT1 is stored in the image management DB 260, then the server 2 reads that medical image data DT1 from the image management DB 260, which is then transmitted to the console 4 (step C5). Upon receipt of the medical image data DT1 from the server 2 (step B5), the console 4 causes the display section 44 to reproduce and display the medical image data DT1 (step B6), and waits for any confirmation instruction input by the user (step B7).

After the user confirms the validity of the additional information, contrast, etc., to make any modification with reference to the displayed medical image, he/she operates the input section 42 to input a confirmation instruction of the medical image. If a rephotographing instruction is input via the input section 42 (“No” at step B7), then the console 4 proceeds to step B1 where a photographing start instruction is again transmitted to the modality 5.

In addition, if a confirmation instruction is detected that is input by the user operating the input section 42 (“Yes” at step B7), then the console 4 combines the examination ID 462a included in the additional information DT3 of the medical image data DT1 with the status information 462b indicative of the completion of the examination to generate status update instruction information 462, which is in turn transmitted to the server 2 (step B8).

Upon receipt of the status update instruction information 462 from the console 4 (step C6), the server 2 updates the list data 262 based on the status update instruction information 462 (step C7), and transmits the list data 262 to the viewer 3 and the console 4, causing them to update respective list data 360 and 460 stored therein (steps B2 and D2).

In FIG. 8, given that the status update instruction information 462 has examination ID 462a of ‘0000001032’ and status information 462b of “EXAMINATION END” when the CT 5a completes the photographing operation and the status update instruction information 462 is transmitted from the CT console 4a to the server 2, then the list data 262 is rewritten based on the status information 462b, and the examination status L30 of “UNDER EXAMINATION” illustrated in FIG. 3 is updated to indicate “EXAMINATION END”.

If the user at viewer 3 side selects a medical image with the examination status L30 of “EXAMINATION END” on the image selection screen 400, i.e., the one with the examination information 266 associated with the status information 268 indicative of the completion of the examination in the list data 262, then the viewer 3 transmits an acquisition request to the server 2 for the medical image by transmitting the examination ID 266a of the selected medical image (step D3).

Upon receipt of the acquisition request for the medical image from the viewer 3, the server 2 searches the image management DB 260 for medical image data DT1 corresponding to the received examination ID. The server 2 then reads that medical image data DT1 from the image management DB 260, which is in turn transmitted to the viewer 3 (step C8).

After transmitting the acquisition request for the medical image at step D4, and upon receipt of the medical image data DT1 from the server 2 (step D5), the viewer 3 causes the display section 34 to display the medical image based on the medical image data DT1 (step D6).

In addition, as in the viewer 3, if the user selects a medical image of “EXAMINATION END” on the image selection screen 400 (step B10), the console 4 also transmits an acquisition request to the server 2 for acquiring the medical image by transmitting the examination ID 266a of the selected medical image (step B11).

Upon receipt of the acquisition request for the medical image from the console 4, the server 2 searches the image management DB 260 for medical image data DT1 corresponding to the received examination ID. The server 2 then reads that medical image data DT1 from the image management DB 260, which is in turn transmitted to the console 4 (step C8).

After transmitting the acquisition request for the medical image at step B11, and upon receipt of the medical image data DT1 from the server 2 (step B12), the console 4 causes the display section 44 to display the medical image based on the medical image data DT1 (step B13).

As can be seen from the above, according to the first embodiment, the PACS 1 comprises a console 4 with functions for controlling photographing operation of a modality 5, as well as for reproducing and displaying medical images, thereby providing data consistency between the console 4, a server 2, and a viewer 3. This may solve deficiencies such as the occurrence of unnecessary communication data or the absence of information regarding the examination flow.

In addition, since medical image data DT1 generated at a modality 5 is stored at the server 2 without intervention by a console 4, it is not necessary to provide a storage section with large capacity at a console 4 or viewer 3 for accumulating and storing such medical image data DT1, which would result in lower hardware costs of the PACS 1. Therefore, this may improve data efficiency of the PACS 1 and reduce its hardware costs.

### Second Embodiment

Referring now to FIGS. 9 to 12, a second embodiment of the PACS 1 will be described below. The PACS 1 in the second embodiment S has substantially the same system configuration as that described in the first embodiment.

According to the second embodiment, a server 2 is implemented to store list data 263 illustrated in FIG. 9, while a console 4 is implemented with such a configuration where the storage section 46 illustrated in FIG. 5C is replaced with a storage section 47 illustrated in FIG. 10. The server 2, the viewer 3, and the console 4 have substantially the same components as those described in relation to the functional configuration in the first embodiment, and so the same reference numerals will be used to refer to the same components as the first embodiment and description thereof will be omitted.

While the communication section 48 in each console 4 comprises a LAN interface or the like as in the server 2 and the viewers 3, for example, it may comprise a serial interface to receive medical image data DT1, directly communicating data with a modality 5.

As illustrated in FIG. 9, list data 263 stores patient information 264, examination information 266, status information 268, and a storage destination address 269, all of which are associated with each other. The storage destination address 269 is such data (e.g., IP address or information for identifying each apparatus) indicating the address of an apparatus in which medical image data DT1 indicated by examination ID 266a is stored.

The PACS 1 in the second embodiment transmits medical image data DT1 generated at modalities 5 to the consoles 4 corresponding to the modalities 5. Each console 4 controls photographing operation of the corresponding modality 5 to transmit status update instruction information 462 to the server 2.

Then, the console 4 temporarily stores the medical image data DT1 received from the modality 5, and transmits status update instruction information 462 indicative of the completion of the examination to the server 2. At this point, the server 2 stores the address of the console 4 receiving the status update instruction information 462 in the list data 263 as a storage destination address 269.

Note that any prior art technique may be utilized as a method of acquiring the address of a console 4, as deemed appropriate. For example, a source address may be acquired from a packet including the received status update instruction information 462 based on a communication protocol (e.g., TCP/IP), or a console 4 may transmit status update instruction information 462 with its own address.

The server 2 transmits list data 263 containing the storage destination address 269 to the console 4 and the viewer 3. If a medical image is selected on the image selection screen 400 of the viewer 3 and the console 4, then the storage destination address 269 corresponding to the medical image is read from the list data, and an acquisition request is transmitted to the apparatus indicated by the storage destination address 269 for acquiring medical image data DT1.

FIG. 10 illustrates an example data configuration of the storage section 47 in each console 4. As illustrated in FIG. 10, the storage section 47 stores list data 461, status update instruction information 462, and an image temporary storage DB 464. The list data 461 has the same data configuration as that of the list data 263 illustrated in FIG. 9. The image temporary storage DB 464 is a database that temporarily stores medical image data DT1 received from a console 4.

According to the second embodiment, medical image data DT1 from a modality 5 is transmitted to and temporarily stored in a console 4. This can be done by setting a destination address to which the modality 5 transmits medical image data DT1 to the address of the console 4.

In response to an instruction being input to reference a medical image through operation an input section 32 by a user, each control section of the viewer 3 and the console 4 reads a storage destination address 269 from the list data 263, and transmits an acquisition request to the apparatus indicated by the storage destination address 269 for acquiring medical image data DT1. Then, upon receipt of the medical image data DT1, the medical image is displayed based on the medical image data DT1.

In addition, the control section 40 of the console 4 clocks the time, and it transmits the all medical image data DT1 stored in the image temporary storage DB 464 to the server 2 when the current time reaches a predetermined time of day (e.g., 0:00 am). Preferably, the times of day for transmitting medical image data DT1 are set to the ones during which the intra-hospital network N would have a less communication load, e.g., late at night, such as 0:00 to 3:00 am, when the medical image data DT1 would be less frequently referenced, and so on.

Upon receipt of medical image data DT1 from the console 4 during the predetermined times of day, the control section 20 of the server 2 searches the list data 263 for examination information 266 that has the examination ID contained in the medical image data DT1. Then, the control section 20 of the server 2 rewrites the storage destination address 269 corresponding to the searched examination information 266 with data indicative of the server 2 (itself) to update the list data 263.

As a result, when an acquisition request is transmitted from a viewer 3 and a console 4 for acquiring medical image data DT1 stored in the image management DB 260, the medical image data DT1 is read from respective image management DBs 260 based on the storage destination address 269, and transmitted to the viewer 3 and the console 4.

FIG. 11 is a flowchart illustrating a specific operation of the PACS 1 in the second embodiment. Note that, in FIG. 10, the same process steps are denoted by the same step numbers as those used in the PACS 1 in the first embodiment illustrated in FIG. 7, and so will not be described in detail below.

Firstly, in the flowchart of FIG. 10, a modality 5 performs photographing operation based on photographing start instructions from consoles 4, and transmits the generated medical image data DT1 to the respective consoles 4, such as from a CT 5a to a CT console 4a in FIG. 12 (steps A1 to A2).

Each of the consoles 4 transmits a photographing start instruction to the corresponding modality 5 based on order information transmitted from HIS, RIS 4, and transmits status update instruction information 462 indicative of the start of the examination to the server 2 (steps B1 to B2).

Then, if a confirmation input through operation of an input section 42 by a user is detected after the medical image data DT1 transmitted from the modality 5 is received, reproduced and displayed by the console (steps B5a to B6), then the console stores the medical image data DT1 in the image temporary storage DB 464 (step B7 to step B7a), and transmits status update instruction information 462 indicative of the completion of the examination to the server 2 (step B8).

Upon receipt of the status update instruction information 462 from the console 4, the server 2 updates list data 263 based on the status update instruction information 462, and transmits it to the viewer 3 and the console 4 (steps C1 to C2 and C6 to C7).

After an image selection screen 400 is displayed based on the list data 263 transmitted from the server 2 (step D2), and if a medical image is selected on the image selection screen 400 in response to operation of the input section 32 (step D3), then the viewer 3 reads a storage destination address 269 corresponding to the selected medical image from the list data 263. Then, the viewer 3 transmits an examination ID to the console 4 or the server 2 indicated by the storage destination address 269, requiring acquisition of medical image data DT1 (step D4).

If an acquisition request is received from the viewer 3 for the medical image data DT1, then the console 4 searches the image temporary storage DB 464 for medical image data DT1 that contains the received examination ID in the examination information of the additional information, which data is then transmitted to the viewer 3, as in the CT console 4a in FIG. 12 (step B15). Similarly, if an acquisition request is received from the viewer 3 for acquiring the medical image data DT1, the server 2 also searches the image management DB 260 for that medical image data DT1, which data is then transmitted to the viewer 3.

Upon receipt of the medical image data DT1 transmitted from the console 4 (step D5), the viewer 3 reproduces and displays the medical image data DT1 (step D6). In addition, after an image selection screen 400 is displayed based on the list data 263 transmitted from the server 2 (step B9), and if a medical image is selected on the image selection screen 400 in response to operation of the input section 32 (step B10), then the console 4 reads a storage destination address 269 corresponding to the selected medical image from the list data 263.

At this point, if the apparatus indicated by the storage destination address 269 is the console 4 itself, then the console 4 reads the medical image data DT1 from the image temporary storage DB 464, which data is then reproduced and displayed on the display section 44 (step B15). Alternatively, if the storage destination address 269 indicates another console 4 or the server 2, not the console 4 itself, then the console 4 transmits an examination ID to the other console 4 or the server 2, requiring acquisition of the medical image data DT1. When the medical image data DT1 is transmitted from the other console 4 or the server 2 in response to the acquisition request for the medical image data DT1, the medical image data DT1 is reproduced and displayed on the display section 44.

On the other hand, the console 4 clocks the time, and it transmits the all medical image data DT1 stored in the image temporary storage DB 464 to the server 2 when the current time reaches a predetermined time of day (step B16) and then deletes the transmitted medical image data DT1 from the image temporary storage DB 464 (step B17). At this point, the server 2 stores the medical image data DT1 received from a console 4, such as the CT console 4a in FIG. 12, in the image management DB 260 (steps C9 to C10).

As can be seen from the above, according to the second embodiment, consoles 4 temporarily store medical image data DT1 provided from modalities 5, and transmit the medical image data DT1 temporarily stored therein to respective viewers 3 in response to acquisition requests from the viewers 3 for acquiring medical images. This may prevent medical image data DT1 from being transmitted to a server 2 each time a medical image is photographed, or prevent intensive access from viewers 3 to a server 2 to reference medical image data DT1. In this way, medical image data DT1 is stored in respective consoles 4 in a distributed manner, which may mitigate degradation in performance of the server 2.

In addition, the medical image data DT1 temporarily stored at each console 4 may be transmitted to the server at those times of day, other than surgery hours during which the medical images would be referenced more frequently, thereby preventing increased load from being imposed on the network.

### INDUSTRIAL APPLICABILITY

The present invention can be used in the medical field and applied to any medical image management systems, for example, where a medical image management apparatus for storing and managing medical image data generated by photographing at a medical image photographing apparatus, and a medical image reproducing apparatus for receiving, reproducing, and displaying the medical image data are connected through a network.

### EXPLANATION OF REFERENCE NUMERAL

1 PACS
2 sever
3 viewers
4 console
5 modalities
20 control section
22 input section
24 display section
26 storage section
28 communication section
30 control section
32 input section
34 display section
36 storage section
38 communication section
40 control section
42 input section
44 display section
46 storage section
47 storage section
48 communication section
262 list data
264 patient information
266 examination information
268 status information
269 storage destination address
462 status update instruction information
464 image temporary storage DB
DT1 medical image data

1-5. (canceled)

6. A medical image management system in which a medical image management apparatus and a medical image reproducing apparatus are connected through a network, comprising:
the medical image management apparatus for storing and managing medical image data generated by photographing operation of a medical image photographing apparatus; and
the medical image reproducing apparatus for receiving the medical image data, and reproducing and displaying the medical image data,
the medical image reproducing apparatus comprising:
a photographing control section for controlling the photographing operation of the medical image photographing apparatus;
a generating section for generating status information indicative of a progress status of the photographing operation of the medical image photographing apparatus based on the controlling by the photograph control section; and
a status transmission section for transmitting the status information generated by the generating section to the medical image management apparatus, and
the medical image management apparatus comprising:
a list preparing section for preparing the list data indicative of the progress status of the photographing operation for each of the medical image data to be generated by the medical image photographing apparatus; and
an update section for updating the list data prepared by the list preparing section, based on status information transmitted from the medical image reproduction apparatus.

7. A medical image management system according to claim 6,
the medical image management apparatus further comprising:
a receiving section for receiving the medical image data generated by the medical image photographing apparatus;
a storage section for accumulating and storing the medical image data received by the receiving section; and
a transmission control section for reading, from the storage section, the medical image data corresponding to an acquisition request from the medical image reproduction apparatus, and transmitting the read medical image data to the medical image reproduction apparatus through the network, and
the medical image reproduction apparatus further comprising:
a request transmission section for transmitting, to the medical image managing apparatus, the acquisition request of the medical image data for which the photographing operation is started by controlling the medical image photographing apparatus by the photographing control section; and
a reproduction control section for receiving the medical image data transmitted from the medical image management apparatus in response to the acquisition request from the request transmission section, and reproducing and the displaying the received medical image data.

8. A medical image management system according to claim 6,
the medical image reproducing apparatus further comprising:
a receiving section for receiving the medical image data generated by the medical image photographing apparatus;
a temporary storage section for temporarily accumulating and storing the medical image data received by the receiving section; and
a transmission control section for reading, from the temporary storage section, the medical image data corresponding to an acquisition request from another apparatus, and transmitting the read medical image data to the another apparatus through the network.

9. A medical image management system according to claim 8,
the medical image reproducing apparatus further comprising:
a selection section for selecting the medical image data stored in the temporary storage section according to operation by a user; and
a reproduction display control section for reading the medical image data selected by the selection section from the temporary storage section, and reproducing and displaying the medical image data.

10. A medical image management system according to claim 7,
the medical image reproducing apparatus further comprising a temporarily stored image transmission section for transmitting the medical image data stored in the temporary storage section to the medical image management apparatus at a predetermined time, and
the medical image management apparatus further comprising a storage section for receiving the medical image data transmitted from the medical image reproducing apparatus at the predetermined time, and accumulating and storing the received medical image data.
